(19) United States
(12) Patent Application Publication
(10) Pub. No.: US 2025/0367982 A1
(43) Pub. Date: Dec. 4, 2025

(54) A CONDUCTIVE TIRE

(71) Applicant: COMPAGNIE GENERALE DES ETABLISSEMENTS MICHELIN, Clermont-Ferrand (FR)

(72) Inventors: REMI REYNAL DE ST-MICHEL, Clermont-Ferrand (FR); MIGUEL ANGEL MARTIN SANCHEZ, Clermont-Ferrand (FR); JOSE MERINO LOPEZ, Clermont-Ferrand (FR); FRANCK DEBLOCK, Clermont-Ferrand (FR); VIVIANE BOMBLAIN, Clermont-Ferrand (FR)

(21) Appl. No.: 18/876,452

(22) PCT Filed: Jun. 29, 2023
(86) PCT No.: PCT/EP2023/067876

§ 371 Date: Dec. 18, 2024

(30) Foreign Application Priority Data
Jun. 30, 2022 (FR) 2206611

(51) Int. Cl. B60C 19/08

(52) U.S. Cl. CPC B60C 19/08

(57) ABSTRACT

A tire has a tread and a pair of sidewalls extending from each of two axial ends of the tread, at least a radially innermost ply being provided with an edge cover layer made of a conductive rubber composition and covering at least a radially inner face of a radially innermost ply and extending as far as an axial distance L, at least one of the sidewalls extending along with the carcass toward underneath the radially innermost ply as far as an axial distance Le, the axial distance L being greater than the axial distance Le, and the edge cover layer provided with the radially innermost ply having a portion contacting with a carcass, the axial distance L is at least equal to 10.0 mm greater than the axial distance Le.

The present invention relates to a tire. The invention relates in particular to a tire with improved conductivity while maintaining manufacturing efficiency.

It is now common for tires, in particular for tires of passenger cars, designed to run at high speeds to embody an additional ply of circumferentially oriented cords. That ply can be placed above the crown reinforcement plies at angles also commonly used. In such a configuration, that ply of circumferentially oriented cords is the radially outermost ply of the tire crown.

In recent years, in terms of economy and environmental considerations, tires provided with fuel efficiency have been required. As a means for obtaining such the tire, reducing the rolling resistance of the tire has been of interest. As a method of obtaining the tire by effectively reducing the rolling resistance, it has been proposed to reduce hysteresis loss which is a major cause of the rolling resistance. As manufacturing a material with reduced hysteresis loss impacts negatively a manufacturing efficiency, tire manufactures are seeking to maintain manufacturing efficiency overall, and one of the way to achieve such manufacturing efficiency is to reduce a number of semi-finished material in factory.

EP0931676 discloses a pneumatic tire in each tire shoulder region which is between a sidewall region and a tread region there is a circumferentially extending ply support strip disposed radially between a carcass ply and an innerliner, the ply support strip comprising a rubber compound containing short discontinuous fibrillated aramid fibers in an amount of between 7 and 15 parts by weight per 100 parts by weight of rubber.

EP2749434 discloses a pneumatic tire comprising a pair of sidewalls whose outer ends being located inward of ends of a belt in an axial direction as integrating a cushion layer with the sidewall. US2017/120682 discloses a tire comprising a crown reinforcement comprising two working crown layers having unequal axial widths. Layer C of rubber compound is placed between ends of the working crown layers. Second layer S of polymer compound is in contact with at least one working crown layer and the carcass reinforcement, which comprises a layer of circumferential reinforcing elements arranged radially between two working crown layers. Distance d between the end of the axially narrowest working layer and the working layer separated from it by layer C is 1.1ø<d<2.2ø, ø being the diameter of the reinforcing elements, in a meridian plane.

Second layer S is made up of a filled elastomer blend having a macro dispersion coefficient Z≥65 and a maximum tan(δ) value less than 0.100. Its complex dynamic shear modulus G*, measured at 10% and 60° C. on the return cycle is greater than 1.35 MPa. US2014/230986 discloses a tire in which weight reduction is achieved without deteriorating internal pressure maintaining performance. The tire includes a liner located inward of a carcass. The liner includes a first inner liner extending on and between one of beads and the other of the beads and along and inward of the carcass; and a pair of second inner liners extending from ends of a belt, respectively, along the first inner liner substantially inward in a radial direction. The second inner liners are located between the first inner liner 66 and the carcass. The first inner liner is formed by a first rubber composition being crosslinked. A base rubber of the first rubber composition includes a butyl rubber. Each second inner liner is formed by a second rubber composition being crosslinked. A base rubber of the second rubber composition includes a diene rubber.

However with the solutions disclosed in these documents, conductivity of a tire would be degraded and therefore cause exceeding of the normative electrical resistance threshold because a conductive path is cut by the sidewall. Such the situation becomes important in particular when combining with a use of low hysteresis loss composition to a calendaring mix of a belt. Thus there is a desire to improve conductivity of a tire without degrading manufacturing efficiency of such the tire by reducing number of semi-finished product.

Therefore, there is a need for a tire which provides improvement on conductivity without degrading manufacturing efficiency by reducing number of semi-finished product.

### Definitions

A “radial direction/orientation” is a direction/orientation perpendicular to axis of rotation of the tire. This direction/orientation corresponds to thickness orientation of the tire.

An “axial direction/orientation” is a direction/orientation parallel to axis of rotation of the tire.

A “circumferential direction/orientation” is a direction/orientation which is tangential to any circle centered on axis of rotation. This direction/orientation is perpendicular to both the axial direction/orientation and the radial direction/orientation.

A “tire” means all types of elastic tire whether or not subjected to an internal pressure.

A “tread” of a tire means a quantity of rubber material bounded by lateral surfaces and by two main surfaces one of which is intended to come into contact with ground when the tire is rolling.

A “ply” is a layer of material such as nylon, polyester or steel in a form of cable, wire or strings arranged mutually parallel with one another with a given pitch coated with a rubber material.

A “conductivity” is evaluated via the electrical resistance of a tire measured in accordance with the WdK 110 Test, lower the electrical resistance means higher the conductivity.

It is thus an object of the invention to provide a tire which provides improvement on conductivity without degrading manufacturing efficiency by reducing number of semi-finished product.

The present invention provides a tire having a tread intended to be in contact with ground during rolling via a contact face and a pair of sidewalls extending from each of two axial end of the tread, the tire comprising at least one ply placed radially inward of the tread, the at least one ply comprising a plurality of parallel reinforcing elements which being extending with an angle A relative to tire circumferential orientation, the angle A being greater than 10 degrees, the tire further comprising a carcass placed radially inward of the at least one ply, at least radially innermost ply among the at least one ply being provided with an edge cover layer made of a conductive rubber composition and covering at least a radially inner face of the radially innermost ply among the at least one ply and extending as far as an axial distance L measured from an axial extremity of the radially innermost ply among the at least one ply, at least one of the sidewall extending along with the carcass toward underneath the radially innermost ply among the at least one ply as far as an axial distance Le measured from the axial extremity of the radially innermost ply among the at least one ply, the axial distance L being greater than the axial distance Le, and the edge cover layer provided with the radially innermost ply among the at least one ply having a portion contacting with the carcass, the axial distance L is at least equal to 10.0 mm greater than the axial distance Le.

This arrangement provides an improvement on conductivity without degrading manufacturing efficiency by reducing number of semi-finished product.

Since at least one of the sidewall extending along with the carcass toward underneath the radially innermost ply among the at least one ply, a material placed underneath the radially innermost ply among the at least one ply with ordinal tire construction can be replaced with the sidewall, thus it is possible to improve the manufacturing efficiency by reducing number of semi-finished product.

Since at least radially innermost ply among the at least one ply being provided with an edge cover layer covering at least a radially inner face of the radially innermost ply among the at least one ply, separation between the ply and the carcass can be avoided, thus it is possible to improve endurance performance.

Since the edge cover layer made of a conductive rubber composition provided with the radially innermost ply among the at least one ply has a portion contacting with the carcass, electrical charges can pass through the carcass via the edge cover layer, thus it is possible to improve conductivity of the tire.

Since the axial distance L is at least equal to 10.0 mm greater than the axial distance Le, it is possible to improve conductivity of the tire.

If this axial distance L is less than 10.0 mm greater than the axial distance Le, there is a risk that the contact between the edge cover layer and the carcass becomes insufficient for creating sufficient conductive path.

This distance L is preferably at least equal to 11.0 mm greater than the axial distance Le, more preferably at least equal to 12.0 mm greater than the axial distance Le and still more preferably at least equal to 15.0 mm greater than the axial distance Le.

In another preferred embodiment, the axial distance Le is at most equal to 15.0 mm.

If this axial distance Le is more than 15.0 mm, there is a risk that a total width of semi-finished product for sidewall becomes too large thus degrading manufacturing efficiency. By setting this axial distance Le at most equal to 15.0 mm, it is possible to improve manufacturing efficiency of such the tire.

This axial distance Le is preferably at most equal to 13.0 mm, more preferably at most equal to 12.0 mm and still more preferably at most equal to 10.0 mm.

In another preferred embodiment, the edge cover layer further covers an axially outermost face and a radially outer face of the radially innermost ply among the at least one ply as far as the axial distance L or smaller measured from the axial extremity of the radially innermost ply among the at least one ply.

According to this arrangement, it is possible to improve endurance performance as the edge cover layer covering the axially outermost face and the radially outer face can prevent separation not only between the ply and the carcass but also between the plies.

In another preferred embodiment, the tire is provided with at least two radially adjacent plies, and each of the at least two plies are provided with the edge cover layer covering the edge portion of each the ply.

According to this arrangement, it is possible to improve endurance performance as the edge cover layer covering the edge portion of each of the at least two plies can prevent separation not only between the ply and the carcass but also between the plies.

In another preferred embodiment, the edge cover layer of one of the radially adjacent plies has a portion contacting with the edge cover layer of the other of the radially adjacent plies.

According to this arrangement, it is further possible to improve endurance performance and conductivity simultaneously as the edge cover layer covering the edge portion of each of the radially adjacent plies can prevent separation not only between the ply and the carcass but also between the plies while reinforcing conductive path to the carcass.

In another preferred embodiment, a volume resistivity of the conductive rubber composition constituting the edge cover layer is at most equal to 5.00×105 Ω-cm.

If this volume resistivity of the conductive rubber composition is more than 5.00×105 Ω-cm, there is a risk that the edge cover layer cannot work efficiently as the conductive path to the carcass. By setting this volume resistivity of the conductive rubber composition at most equal to 5.00×105 Ω-cm, it is possible to improve conductivity of the tire.

This volume resistivity of the conductive rubber composition constituting the edge cover layer is preferably at most equal to 4.00×105 Ω-cm, more preferably at most equal to 3.75×105 Ω-cm.

In another preferred embodiment, tire further comprises at least one conductive path opening to the contact face.

According to this arrangement, it is possible to further improve conductivity of the tire as electrical charges can also pass through the at least one conductive path opening to the contact face to ground.

According to the arrangements described above, it is possible to provide a tire which provides improvement on conductivity without degrading manufacturing efficiency by reducing number of semi-finished product.

Other characteristics and advantages of the invention arise from the description made hereafter in reference to the annexed drawings which show, as nonrestrictive examples, the embodiment of the invention.

In these drawings:

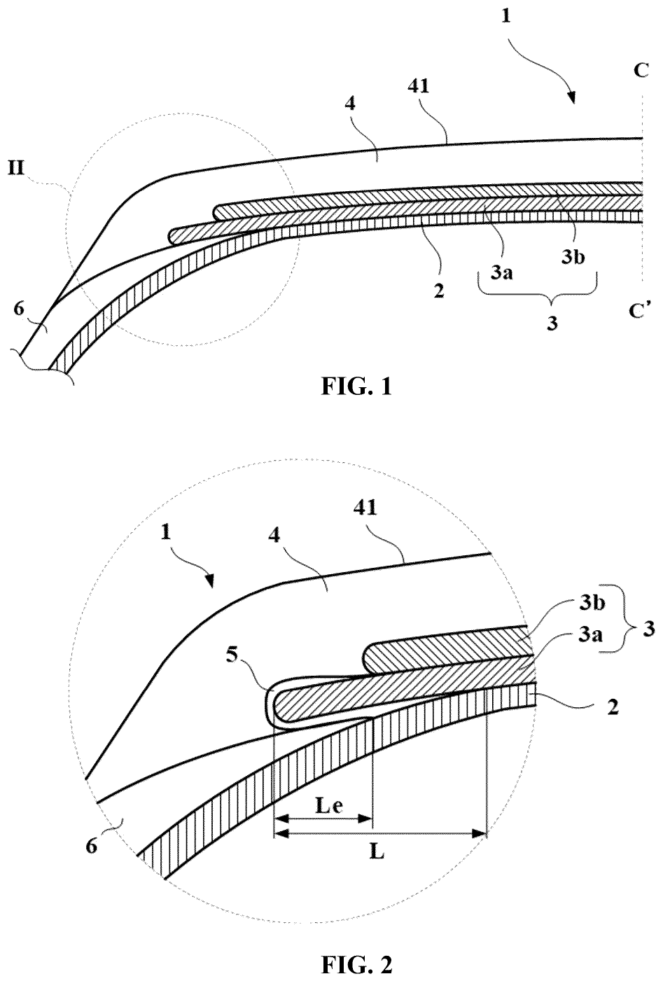

FIG. 1 is a schematic cross sectional view of a tire according to a first embodiment of the present invention;

FIG. 2 is an enlarged schematic view showing a portion indicated as II in FIG. 1;

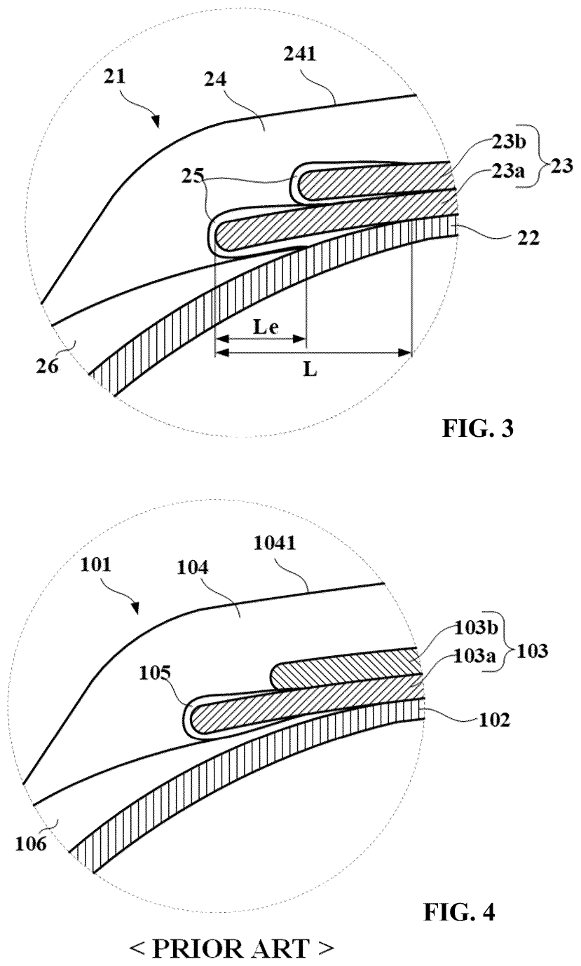

FIG. 3 is an enlarged schematic view of a tire according to a second embodiment of the present invention corresponding to the portion indicated as II in FIG. 1;

FIG. 4 is an enlarged schematic view of a tire according to prior art corresponding to the portion indicated as II in FIG. 1.

Preferred embodiment of the present invention will be described below referring to the drawings.

A tire 1 according to a first embodiment of the present invention will be described referring to FIGS. 1 and 2.

FIG. 1 is a schematic cross sectional view of a tire according to a first embodiment of the present invention. FIG. 2 is an enlarged schematic view showing a portion indicated as II in FIG. 1. Portions other than shown in these FIG. 1 and FIG. 2 are typical radial tire construction thus explanation of such portions will be omitted.

The tire 1 is a tire having a tread 4 intended to be in contact with ground during rolling via a contact face 41 and a pair of sidewalls 6 (only one shown in FIG. 1) extending from each of two axial end of the tread 4, the tire 1 comprising at least one ply 3 placed radially inward of the tread 4, the at least one ply 3 comprising a plurality of parallel reinforcing elements (not shown) which being extending with an angle A (not shown) relative to tire circumferential orientation, the angle A being greater than 10 degrees and often the case smaller than 45 degrees when applied to passenger car tire. In the present embodiment, the tire 1 comprising two plies 3a, 3b, the angle A is 25 degrees.

As shown in FIG. 1 and FIG. 2, the tire 1 further comprising a carcass 2 placed radially inward of the at least one ply 3.

As shown in FIG. 2, at least radially innermost ply 3a among the at least one ply 3 being provided with an edge cover layer 5 made of a conductive rubber composition and covering at least a radially inner face of the radially innermost ply 3a among the at least one ply 3 and extending as far as an axial distance L measured from an axial extremity of the radially innermost ply 3a among the at least one ply 3, at least one of the sidewall 6 extending along with the carcass 2 toward underneath the radially innermost ply 3a among the at least one ply 3 as far as an axial distance Le measured from the axial extremity of the radially innermost ply 3a among the at least one ply 3. The axial distance L is greater than the axial distance Le. The axial distance L is at least equal to 10.0 mm greater than the axial distance Le. The axial distance Le is at most equal to 15.0 mm. In the present embodiment, the axial distance Le is 7.0 mm, and the axial distance L is 16.0 mm greater than the axial distance Le.

As shown in FIG. 2, the edge cover layer 5 further covers an axially outermost face and a radially outer face of the radially innermost ply 3a among the at least one ply 3 as far as the axial distance L or smaller measured from the axial extremity of the radially innermost ply 3a among the at least one ply 3.

As shown in FIG. 2, the edge cover layer 5 provided with the radially innermost ply 3a among the at least one ply 3 has a portion contacting with the carcass 2.

A volume resistivity of the conductive rubber composition constituting the edge cover layer 5 is at most equal to 5.00×105 Ω-cm. In this present embodiment, the volume resistivity of the conductive rubber composition constituting the edge cover layer 5 is 3.50×105 Ω-cm.

Since at least one of the sidewall 6 extending along with the carcass 2 toward underneath the radially innermost ply 3a among the at least one ply 3, a material placed underneath the radially innermost ply 3a among the at least one ply 3 with ordinal tire construction can be replaced with the sidewall 6, thus it is possible to improve the manufacturing efficiency by reducing number of semi-finished product.

Since at least radially innermost ply 3a among the at least one ply 3 being provided with an edge cover layer 5 covering at least a radially inner face of the radially innermost ply 3a among the at least one ply 3, separation between the ply 3 and the carcass 2 can be avoided, thus it is possible to improve endurance performance.

Since the edge cover layer 5 made of a conductive rubber composition provided with the radially innermost ply 3a among the at least one ply 3 has a portion contacting with the carcass 2, electrical charges can pass through the carcass 2 via the edge cover layer 5, thus it is possible to improve conductivity of the tire 1.

Since the axial distance L is at least equal to 10.0 mm greater than the axial distance Le, it is possible to improve conductivity of the tire 1.

If this axial distance L is less than 10.0 mm greater than the axial distance Le, there is a risk that the contact between the edge cover layer 5 and the carcass 2 becomes insufficient for creating sufficient conductive path.

This distance L is preferably at least equal to 11.0 mm greater than the axial distance Le, more preferably at least equal to 12.0 mm greater than the axial distance Le and still more preferably at least equal to 15.0 mm greater than the axial distance Le.

Since the axial distance Le is at most equal to 15.0 mm, it is possible to improve manufacturing efficiency of such the tire 1.

If this axial distance Le is more than 15.0 mm, there is a risk that a total width of semi-finished product for sidewall 6 becomes too large thus degrading manufacturing efficiency.

This axial distance Le is preferably at most equal to 13.0 mm, more preferably at most equal to 12.0 mm and still more preferably at most equal to 10.0 mm.

Since the edge cover layer 5 further covers an axially outermost face and a radially outer face of the radially innermost ply 3a among the at least one ply 3 as far as the axial distance L or smaller measured from the axial extremity of the radially innermost ply 3a among the at least one ply 3, it is possible to improve endurance performance as the edge cover layer 5 covering the axially outermost face and the radially outer face can prevent separation not only between the ply 3 and the carcass 2 but also between the plies 3.

Since a volume resistivity of the conductive rubber composition constituting the edge cover layer 5 is at most equal to 5.00×105 0-cm, it is possible to improve conductivity of the tire 1.

If this volume resistivity of the conductive rubber composition is more than 5.00×105 Ω-cm, there is a risk that the edge cover layer 5 cannot work efficiently as the conductive path to the carcass 2.

This volume resistivity of the conductive rubber composition constituting the edge cover layer 5 is preferably at most equal to 4.00×105 Ω-cm, more preferably at most equal to 3.75×105 Ω-cm.

A tire 21 according to a second embodiment of the present invention will be described referring to FIG. 3. FIG. 3 is an enlarged schematic view of a tire according to a second embodiment of the present invention corresponding to the portion indicated as II in FIG. 1. The construction of this second embodiment is similar to that of the first embodiment other than the arrangement shown in FIG. 3, thus description will be made referring to FIG. 3.

As shown in FIG. 3, the tire 21 is a tire having a tread 24 intended to be in contact with ground during rolling via a contact face 241 and a pair of sidewalls 26 (only one shown in FIG. 3) extending from each of two axial end of the tread 24, the tire 21 comprising at least one ply 23 placed radially inward of the tread 24, the at least one ply 23 comprising a plurality of parallel reinforcing elements (not shown) which being extending with an angle A (not shown) relative to tire circumferential orientation, the angle A being greater than 10 degrees and often the case smaller than 45 degrees when applied to passenger car tire. In the present embodiment, the tire 21 comprising two plies 23a, 23b, the angle A is 27 degrees.

As shown in FIG. 3, the tire 21 further comprising a carcass 22 placed radially inward of the at least one ply 23.

As shown in FIG. 3, at least radially innermost ply 23a among the at least one ply 23 being provided with an edge cover layer 25 made of a conductive rubber composition and covering at least a radially inner face of the radially innermost ply 23a among the at least one ply 23 and extending as far as an axial distance L measured from an axial extremity of the radially innermost ply 23a among the at least one ply 23, at least one of the sidewall 6 extending along with the carcass 22 toward underneath the radially innermost ply 23a among the at least one ply 23 as far as an axial distance Le measured from the axial extremity of the radially innermost ply 23a among the at least one ply 23. The axial distance L is greater than the axial distance Le. The axial distance L is at least equal to 10.0 mm greater than the axial distance Le. The axial distance Le is at most equal to 15.0 mm.

As shown in FIG. 3, the tire 21 is provided with at least two radially adjacent plies 23a, 23b, and each of the at least two plies 23 are provided with the edge cover layer 25 covering the edge portion of each the ply 23a, 23b. The tire 21 further comprises at least one conductive path opening to the contact face 241 (not shown).

As shown in FIG. 3, the edge cover layer 25 of one of the radially adjacent plies 23a, 23b has a portion contacting with the edge cover layer 25 of the other of the radially adjacent plies 23a, 23b.

Since the tire 21 is provided with at least two radially adjacent plies 23a, 23b, and all each of the at least two plies 23 are provided with the edge cover layer 25 covering the edge portion of each the ply 23a, 23b, it is possible to improve endurance performance as the edge cover layer 25 covering the edge portion of each of the at least two plies 23 can prevent separation not only between the ply 23 and the carcass 22 but also between the plies 23.

Since the edge cover layer 25 of one of the radially adjacent plies 23 has a portion contacting with the edge cover layer 25 of the other of the radially adjacent plies, it is further possible to improve endurance performance and conductivity simultaneously as the edge cover layer 25 covering the edge portion of each of the radially adjacent plies 23 can prevent separation not only between the ply 23 and the carcass 22 but also between the plies 23 while reinforcing conductive path to the carcass 22.

Since the tire 21 further comprises at least one conductive path opening to the contact face 241, it is possible to further improve conductivity of the tire 21 as electrical charges can pass through the at least one conductive path opening to the contact face 241 to ground.

A construction of at least one conductive path opening to the contact face 241 may be in any form known to those skilled in the art. A rubber composition constituting the at least one conductive path opening to the contact face 241 may be made with the same rubber composition constituting the edge cover layer 25. The at least one conductive path opening to the contact face 241 may extend beyond radially innermost of the tread 24.

The invention is not limited to the examples described and represented and various modifications can be made there without leaving its framework.

FIG. 4 is an enlarged schematic view of a tire according to prior art corresponding to the portion indicated as II in FIG. 1. In this FIG. 4, a tire 101 having a tread 104 intended to be in contact with ground during rolling via a contact face 1041 and a pair of sidewalls 106 extending from each of two axial end of the tread 104, the tire 101 comprising at least one ply 103 (two plies; 103a and 103b in this prior art) placed radially inward of the tread 104, the at least one ply 103 comprising a plurality of parallel reinforcing elements (not shown) which being extending with an angle A relative to tire circumferential orientation, the angle A being greater than 10 degrees, the tire 101 further comprising a carcass 102 placed radially inward of the at least one ply 103, at least radially innermost ply 103a among the at least one ply 103 being provided with an edge cover layer 105 made of a conductive rubber composition and covering at least a radially inner face of the radially innermost ply 103a among the at least one ply 103, at least one of the sidewall 106 extending along with the carcass 102 toward underneath the radially innermost ply among the at least one ply 103, the edge cover layer 105 provided with the radially innermost ply among the at least one ply 103 has no portion contacting with the carcass 102. The radially outermost ply 103b among the at least one ply 103 being provided without an edge cover layer.

In order to confirm the effect of the present invention, two types of tires of Example to which the present invention is applied and other types of tires of Reference were prepared.

The Example 1 was a tire as described in the above first embodiment. The Example 2 was also a tire as described in the above first embodiment made with a low hysteresis loss composition to a calendaring mix of belts (plies). The Reference 1 was a tire according to prior art; basically the same construction as the Example 1 but the edge cover layer provided with the radially innermost ply didn't have the portion contacting with the carcass. The Reference 2 was also a tire according to prior art made with a low hysteresis loss composition to a calendaring mix of belts (plies). All the Examples and References were made of, other than indicated, the same tubber-based material, typical rubber-based material used for passenger car tire. The tire dimension of Examples and References were both 245/45R18, mounted onto an electrically conductive rim of 8.0 J×18, inflated to 200 kPa.

### Conductivity Tests:

The electric resistance of the tires was measured in accordance with WdK 110 by placing an assembly of a test tire and a rim on a steel plate, applying a load of 595 kg to the tire then flowing electric current of 1,000V between the rim and the steel plate to read electric resistance by means of high resistance meter.

The results are shown in table 1. In this table 1, results are represented by “X” meaning above 108Ω threshold, “G” meaning on or below 108Ω and “V” meaning on or below 107Ω.

TABLE 1

| | Example 1 | Example 2 | Reference 1 | Reference 2 |
|---|---|---|---|---|
| Electric resistance | V | G | X | X |

As seen from table 1, the Example shows improvement on conductivity represented by electric resistance while improving manufacturing efficiency by reducing number of semi-finished product, which cannot be achieved by tires disclosed in prior arts.

### REFERENCE SIGNS LIST

1, 21 tire
2, 22 carcass
3, 23 ply
4, 24 tread
41, 241 contact face
5, 25 edge cover layer
6, 26 sidewall

1.-7. (canceled)

8. A tire having a tread intended to be in contact with ground during rolling via a contact face and a pair of sidewalls extending from each of two axial ends of the tread,
the tire comprising at least one ply placed radially inward of the tread,
the at least one ply comprising a plurality of parallel reinforcing elements which extend with an angle A relative to tire circumferential orientation, the angle A being greater than 10 degrees,
the tire further comprising a carcass placed radially inward of the at least one ply,
at least a radially innermost ply among the at least one ply being provided with an edge cover layer made of a conductive rubber composition and covering at least a radially inner face of the radially innermost ply among the at least one ply and extending as far as an axial distance L measured from an axial extremity of the radially innermost ply among the at least one ply,
at least one of the sidewalls extending along with the carcass toward underneath the radially innermost ply among the at least one ply as far as an axial distance Le measured from the axial extremity of the radially innermost ply among the at least one ply,
the axial distance L being greater than the axial distance Le, and the edge cover layer provided with the radially innermost ply among the at least one ply having a portion contacting with the carcass,
wherein the axial distance L is at least equal to 10.0 mm greater than the axial distance Le.

9. The tire according to claim 8, wherein the axial distance Le is at most equal to 15.0 mm.

10. The tire according to claim 8, wherein electrical charges can pass through the carcass via a portion of the edge cover layer contacting the carcass.

11. The tire according to claim 8, wherein the edge cover layer further covers an axially outermost face and a radially outer face of the radially innermost ply among the at least one ply as far as the axial distance L or smaller measured from the axial extremity of the radially innermost ply among the at least one ply.

12. The tire according to claim 8, wherein the tire is provided with at least two radially adjacent plies, and wherein each of the at least two plies are provided with the edge cover layer covering the edge portion of each ply.

13. The tire according to claim 12, wherein the edge cover layer of one of the radially adjacent plies has a portion contacting with the edge cover layer of the other of the radially adjacent plies.

14. The tire according to claim 8, wherein a volume resistivity of the conductive rubber composition constituting the edge cover layer is at most equal to 5.00×10⁵ Ω·cm.

15. The tire according to claim 8, wherein the tire further comprises at least one conductive path opening to the contact face.

16. The tire according to claim 8, wherein the tire further comprises at least one conductive path cut by the sidewall.
